(19) United States
(12) Patent Application Publication
(10) Pub. No.: US 2021/0099319 A1
(43) Pub. Date: Apr. 1, 2021

(54) SYSTEMS AND METHODS FOR ONBOARDING IN DISTRIBUTED ACCESS ARCHITECTURES

(71) Applicant: ARRIS Enterprises LLC, Suwanee, GA (US)

(72) Inventors: Chris Busch, Arnprior (CA); David Baran, Haverford, PA (US)

(21) Appl. No.: 17/038,272

(22) Filed: Sep. 30, 2020

Related U.S. Application Data
(60) Provisional application No. 62/907,804, filed on Sep. 30, 2019.

(51) Int. Cl. H04L 12/28; H04N 21/61; H04L 29/12

(52) U.S. Cl. CPC H04L 12/2801; H04L 12/2856; H04L 61/2015; H04L 61/6022; H04N 21/6118

(57) ABSTRACT

Systems and methods for onboarding remote devices in a Distributed Access Architecture. Such systems and methods may include an Onboarding Service Device (OSD) having a network address returnable to the remote device by a DHCP server so that the remote device may contact the OSD directly after receiving its address.

### CROSS REFERENCE TO RELATED APPLICATIONS

None

### BACKGROUND

The subject matter of this application relates to systems and methods for onboarding remote devices in distributed access architectures.

Cable Television (CATV) services provide content to large groups of subscribers from a central delivery unit, called a “head end,” which distributes channels of content to its subscribers from this central unit through a branch network comprising a multitude of intermediate nodes. Modern Cable Television (CATV) service networks, however, not only provide media content such as television channels and music channels to a customer, but also provide a host of digital communication services such as Internet Service, Video-on-Demand, telephone service such as VoIP, and so forth. These digital communication services, in turn, require not only communication in a downstream direction from the head end, through the intermediate nodes and to a subscriber, but also require communication in an upstream direction from a subscriber and to the content provider through the branch network.

To this end, CATV head ends have historically included a Cable Modem Termination System (CMTS), used to provide high speed data services, such as video, cable Internet, Voice over Internet Protocol, etc. to cable subscribers. Typically, a CMTS will include both Ethernet interfaces (or other more traditional high-speed data interfaces) as well as RF interfaces so that traffic coming from the Internet can be routed (or bridged) through the Ethernet interface, through the CMTS, and then onto the optical RF interfaces that are connected to the cable company's hybrid fiber coax (HFC) system. Downstream traffic is delivered from the CMTS to a cable modem in a subscriber's home, while upstream traffic is delivered from a cable modem in a subscriber's home back to the CMTS. Many CATV systems have combined the functionality of the CMTS with the video delivery system (EdgeQAM) in a single platform called the Converged Cable Access Platform (CCAP).

Motivated by a desire to deliver multi-gigabit services, cable operators have recently begun to migrate from the centralized architecture described above to different types of distributed access architectures that relocate functions that traditionally resided in the CCAP of the head end deeper into the fiber network, closer to the subscriber. Doing so helps to relieve the space, hardware and cooling constraints of the head end as node counts continue to grow exponentially. Such distributed architectures include Remote PHY, Remote MAC-PHY, Remote OLT PON, among others. Each different type of distributed access architecture (DAA), however distributes different portions of the network architecture throughout the network relative to other such architectures, therefore requiring unique protocols for discovering downstream devices and integrating the discovered devices into the network, a process referred to as “onboarding.” Thus, as networks grow to encompass different types of DAAs, onboarding of devices in these different DAAs becomes more complicated.

What is desired, therefore, are improved systems and methods for onboarding devices in networks having different types of distributed access architectures.

### BRIEF DESCRIPTION OF THE DRAWINGS

For a better understanding of the invention, and to show how the same may be carried into effect, reference will now be made, by way of example, to the accompanying drawings, in which:

FIG. 1 shows a first system for onboarding and integrating devices into an HFC network having Remote-PHY devices, Remote MAC-PHY devices, and Remote OLT PON devices.

FIG. 2 shows a second system for onboarding and integrating devices into an HFC network having Remote-PHY devices, Remote MAC-PHY devices, and Remote OLT PON devices.

FIGS. 3A to 3C show steps used in the system of FIG. 2 to onboard and integrate network devices.

### DETAILED DESCRIPTION

As already noted, distributed access architectures relocate functions that traditionally resided in the CCAP of the head end deeper into the fiber network so as to improve network performance. In particular, moving functionality traditionally resident in a head end closer to the subscriber results in less noise, higher modulation, more capacity, and higher speeds. Different types of DAAs move different functions into the network, however. These different functions, for example, include Medium Access Control (MAC) layer functions and Physical (PHY) layer functions. Thus, a remote-PHY architecture pushes into the network physical layer devices, which are responsible for the transmission and reception of data between an access terminal and an access network, and support electrical or mechanical interfaces connecting to the physical medium. A remote MAC-PHY architecture will also push into the network the MAC layer devices, which are responsible for controlling how devices in a network gain access to a medium and grant permission to transmit data. In addition, some In addition, a Remote OLT PON network pushes into the network an Optical Line Terminal, a network element that controls upstream and downstream signals to manage traffic and which is typically included in a head end in traditional Passive Optical Network (PON) topologies. Those of ordinary skill in the art will recognize that other DAA variants may be used, e.g. a Split-MAC architecture that moves the PHY layer and a portion of the MAC layer out of a head end, into the fiber network.

Cable operators deploying a Distributed Access Architecture (DAA) may therefore have multiple access devices at the edge of the network, each of which require onboarding via discovery, authentication, provisioning, etc. in order to service customer devices such as gateways, NIDs, etc. but that are each configured for onboarding through different DAA protocols. Though each of these protocols typically relies on DHCP communications for such onboarding, it is still problematic for operators to integrate the various DAA DHCP protocols during onboarding to maintain associations of management and provisioning systems to the numerous DAA back office platforms to which each of these device types must connect.

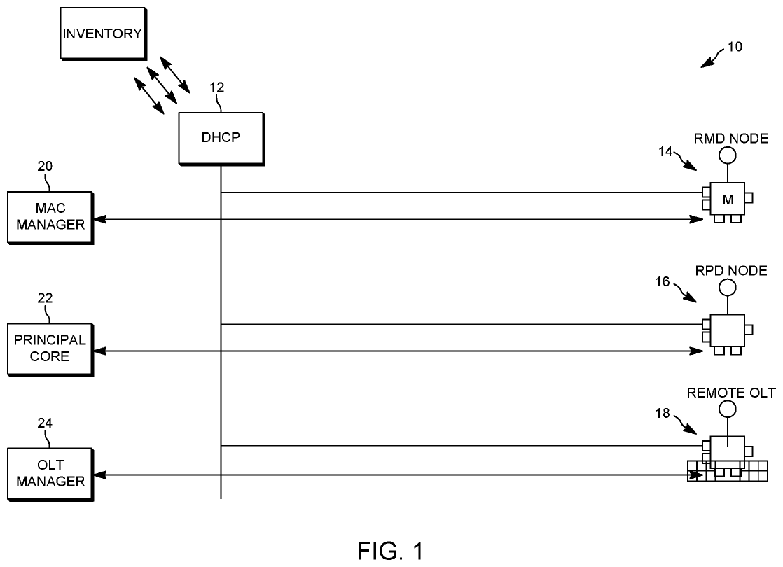

Referring to FIG. 1, for example, a DAA network 10 may include a DHCP server 10 used to onboard various DAA devices respectively connected via a Remote-MAC node 14 and a Remote-PHY node 16, as well as to onboard a Remote OLT 18. The Remote-MAC node 14 contacts the DHCP server 12 to address devices attached to the RMD node 14, and also relies on the DHCP sever 12 to discover a MAC Manager 20, which is required to provision and monitor the current state of the RMD-node 14 using a RESTCONF or vendor specific session. The initialization of the RMD-Node 14 to the principle core over RESTCONF sends initial capabilities of devices attached to the RMD-node to the MAC Manager 20.

Similarly, the Remote-PHY node 16 contacts the DHCP server 12 address devices connected to the network through the Remote PHY node 16 and to discover a principle core 22. The principle core 22 is required to provision and to monitor the current state of the RPD node 16 using a Generic Configuration Protocol (GCP) session. The initialization of the RPD node 16 to the principle core 22 over GCP uses communications port 8190 and sends initial capabilities of the device to the core. Likewise, the Remote OLT 18 relies on the DHCP server 12 to discover an OLT Manager 24, which provides the management system for the Remote OLT 18, and provided in a software defined network style of architecture.

Each onboarding process for the respective devices 14, 16, and 18 requires that the DHCP server 12 convey unique inventory management procedures to these respective devices. For example, both the Remote MAC-PHY and Remote PHY device onboarding procedures require that DHCP systems must be made aware of device form inventory so that remote devices can be assigned to its MAC manager 20 and Principle core 22, respectively. Similarly, a Remote OLT 18 now separated from its management system in a software defined network style of architecture requires provisioning and ongoing management. The Remote-OLT device identifies itself by its MAC address and DHCP client option 60 of the device type. This requires the DHCP server 12 to be made aware of device form inventory to assign the remote OLT 18 to the OLT Manager 24 in the network.

Deployed distributed access architectures having multiple access elements, each of which requiring different discovery, authentication, and provisioning protocols thus make it difficult for operators to integrate the disparate onboarding procedures at the initial stage of discovering and provisioning devices, since DHCP systems are not intended to function as identity and inventory solutions.

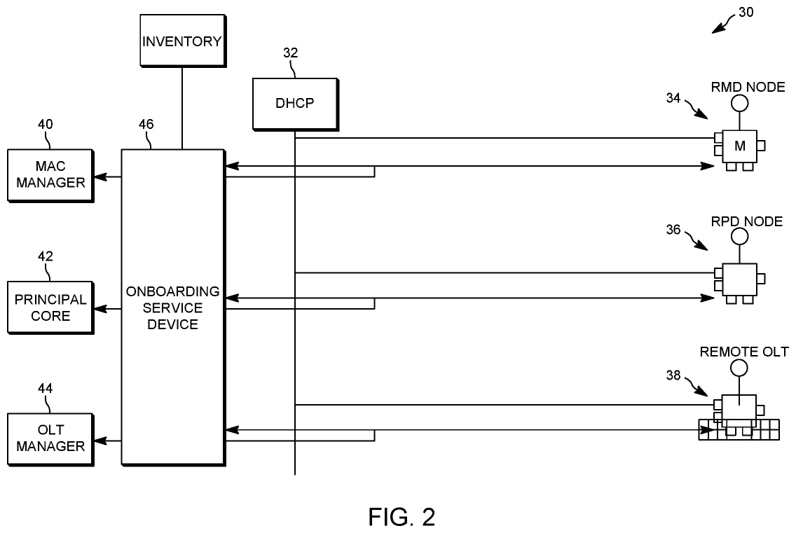

FIG. 2 shows a DAA network 30 that may include a DHCP server 30 used to onboard various DAA devices respectively connected via a Remote MAC-PHY node 34 and a Remote PHY node 36, as well as to onboard a Remote OLT 38. Unlike the system 10 of FIG. 1, the system 30 includes an Onboarding Service Device (OSD) 46, which is a device with responsibility to abstract the need for DHCP systems to have any awareness of the additional management or principle core systems introduced through DAA deployment. Based on device type, the DHCP server 32 simply offers the location of the OSD 46 and is no longer required to carry knowledge of all the new DAA related management and principle core systems nor hold any device specific records or logic beyond the standard use of DHCP IP address records. The respective devices 34, 36, 38 in turn use the information to contact the OSD 46, which includes all necessary device form inventory to assign the remote devices 34, 36, and 38 to the respectively appropriate one of the MAC manager 40, the Principal Core 42, and the OLT manager 24.

For example, when a device connected to the Remote MAC-PHY node 34 contacts the DHCP server 32, DHCP packets emitted from such devices indicate a unique device identity by a MAC address, and using client option 60 of their device type. The DHCP server 32 can use the information of the device type to respond by redirecting the device the OSD 46, where association of the device type and its identity may be made to a subsequent management element such as a MAC manager 40.

Similarly, when a device connected to the Remote PHY node 36 contacts the DHCP server 32, DHCP packets emitted from such devices indicate a unique device identity by a MAC address, and using client option 60 of their device type. The DHCP server 60 can use the information of the device type to respond by redirecting the device the OSD 46, where association of the device type and its identity may be made to a subsequent management element such as a Principal core 42.

When Remote OLT devices 38 contact the DHCP server 32, the server 32 may direct such devices to the Onboarding Service Device 46 F which will accept incoming connections over a private VLAN and socket combination based on the vendor R-OLT implementation to configure the R-OLT with its OLT Manager 44 based on the identity of the device.

Preferably, the Onboarding Service Device 46, which implements an onboarding service function, is a multi-protocol interworking service with device identity integration and device management redirection functionality. Interwork multiple protocols is a requirement for communications with DAA elements, where Remote-PHY devices require GCP, Remote-MAC-PHY devices require RESTCONF, Remote OLT devices require vendor specific protocol. Identity integration is simply the knowledge of device unique identification, namely a MAC address with a defined network function such as a principle core or manager. Preferably, redirect for each of the device types is a unique method by standard or vendor specific implementation. Redirect object exists as two independent and isolated designs in the Remote PHY and Remote MAC PHY specifications. Remote OLT PON systems implement a vendor specific writable object held in the R-OLT device to indicate its OLT Manager communications.

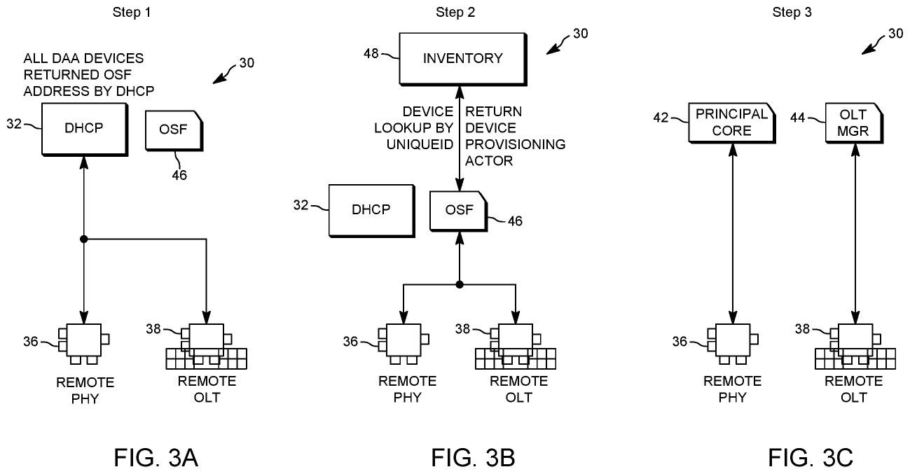

FIGS. 3A to 3C generally illustrate a procedure by which a remote device in a DAA architecture is directed to the appropriate management device. Though these figures use the example of a Remote OLT and a Remote PHY device to illustrate the exemplary procedure, those of ordinary skill in the art will recognize that the same procedure may be implemented with respect to a Remote MAC-PHY device. As shown in FIG. 3A, a Remote PHY device and a Remote OLT device may each attempt to connect to network 30 by contacting DHCP server 32, which provides a network address of the OSD 46 which is capable of performing onboarding service functions. As seen in FIG. 3B, each of the devices 36 and 38 use this address to contact the OSD 46, which uses the device IDs to retrieve information from an inventory provisioning module 48, which returns the address of a relevant device provisioning actor, e.g. a principal core, an OLT manager, etc. The inventory provisioning module may in some embodiments preferably include a table that associates each of a plurality of different management devices, such as an OLT manager, a Principal core, a MAC manager etc. with respectively different combinations of device types and device roles. Device types may include Remote-PHY, Remote-MACPHY, Remote-OLT, and Remote Switch while associations to device roles serving these device types may include Principal Core, AUX Core, and IP Service Core such as Broadband Network Gateway (BNG). As seen in FIG. 3C, the device 36 uses the address that it receives to connect to a Principal core 42 and the device 38 use the address that it receives to connect to OLT manager 44, where each may complete their needed onboarding procedures.

In some embodiments of the foregoing disclosure, the systems and methods may be used to deploy devices in an “inventoryless” fashion, or to reconfigure devices originally intended for one DAA architecture to conform to a new architecture. For example, the devices 34, 36, and 38 shown in FIGS. 2 and 3 may be deployed as fungible devices by which the OSD 46 and may provide the device with firmware and/or software and an associated address for a management device, such as an OLT manager or a MAC manager, necessary for operation of the device in a desired DAA architecture and/or a desired functionality, e.g. a node, an RPD, an RMD, an OLT, an Ethernet Switch, etc.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. An Onboarding Service Device (OSD) in a distributed access architecture (DAA) for a hybrid fiber coaxial (HFC) network connected to a DHCP server, the OSD configured, without connection to the DHCP server, to:
(i) receive first information from a remote device in the DAA; and
(ii) use the first information to connect the remote device to a management module capable of onboarding the device to the HFC network.

2. The OSD of claim 1 where the first information includes at least one of a device ID and a device type.

3. The OSD of claim 1 where the remote device is at least one of a Remote PHY, a Remote MAC-PHY, and a Remote OLT.

4. The OSD of claim 1 where the OSD connects the remote device to the management module by sending second information to the remote device, the second information comprising a network address of the management module.

5. The OSD of claim 1 where the OSD receives the second information from an inventory provisioning module.

6. The OSD of claim 1 configured as a multi-protocol interworking service with device identity integration and device management redirection functionality.

7. The OSD of claim 1 configured to receive the first information over a private VLAN and socket combination.

8. A method for onboarding a remote device in a distributed access architecture (DAA) of a hybrid fiber coaxial (HFC) network connected to a DHCP server, the method comprising;
the remote device contacting the DHCP server and providing it with a network address of the device;
the DHCP server returning a network address of an Onboarding Service Device (OSD) to the remote device;
the remote device using the network address of the OSD to connect to the OSD; and
the OSD providing onboarding information to the remote device.

9. The method of claim 8 where the onboarding information includes an address to a management module capable of onboarding the remote device.

10. The method of claim 9 where the remote device uses the address to connect to the management module.

11. The method of claim 8 where the remote device disconnects from the DHCP server after receiving the network address of the OSD.

12. The method of claim 8 where the remote device provides at least one of a device ID and a device type to the OSD.

13. The method of claim 12 where the OSD connects to an inventory provisioning module after receiving the at least one of a device ID and a device type to the OSD.

14. The OSD of claim 13 where the onboarding information includes an address to a management module capable of onboarding the remote device and the OSD receives the address of the management module from the inventory provisioning module.

15. The method of claim 8 where the remote device is at least one of a Remote PHY, a Remote MAC-PHY, and a Remote OLT.

16. The method of claim 8 where the OSD is configured as a multi-protocol interworking service with device identity integration and device management redirection functionality.

17. The method of claim 8 where the OSD is configured to connect to the remote device over a private VLAN and socket combination.
